(19) United States
(12) Patent Application Publication
(10) Pub. No.: US 2016/0146726 A1
(43) Pub. Date: May 26, 2016

(54) WEARABLE DEVICE FOR DETECTION OF CONTAMINANTS AND METHOD THEREOF

(71) Applicant: VIPUL CHAWLA, SAN JOSE, CA (US)

(72) Inventor: KAMAL AGGARWAL, SAN JOSE, CA (US)

(21) Appl. No.: 14/553,537

(22) Filed: Nov. 25, 2014

(51) Int. Cl. G01N 21/31

(52) U.S. Cl. CPC G01N 21/31; G01N 2201/061

(57) ABSTRACT

Generally described, the devices and methods provided herein are directed to wearables having a spectrometer for analyzing a chemical composition of a substance. The substance can be a solid, liquid, or gas. Spectrometer readings can be matched against known chemical compositions that are stored locally or remotely. After a spectrometer reading, a notification mechanism can be activated. The notification mechanism can activate when the composition of the substance has been determined or the substance is determined to be harmful and/or safe.

### TECHNICAL FIELD

This disclosure generally relates to a wearable and more particularly, to a ring having a spectrometer for detecting contaminants.

### BACKGROUND

Statistics show that every six minutes a women is raped in the United States. Alarmingly, eighty-four percent of the victims were raped by someone they knew. Furthermore, fifty-seven percent of these assaults took place on a date. Alcohol and drugs have played a significant role in these incidents. Upwards of seventy-five percent of date rape incidents involve alcohol or other drugs. By subduing a victim's consciousness or incapacitating them, the drugs can lead to short-term amnesia, leaving a victim unclear about what occurred.

A number of solutions have been proposed to detect the presence of drugs in beverages. The methods used vary from chemical analysis to advanced electronic signal processing. Drinksavvy's solution includes a litmus-style test for cups and straws. A chemical based indicator can change colors when it comes in contact with some of the commonly used date rape drugs. Drink Safe Tech has developed a coaster coated with a chemical which can change color when it comes in contact with a liquid containing two of the most commonly used date rape drugs. PD.ID developed an electronic device for detection of drugs in drinks. Using static signal processing, the device can detect specific changes in the conductivity, which are attributable to the presence of date rape drugs.

Chemical detection methods, as described above, detect only very specific compounds and are limited to a one time use. Furthermore, electronic detection systems are not very reliable, as they often give false alarms even in the presence of small amounts of dishwashing detergents. Other devices are required to be dipped into the drink, which can be very awkward in most social settings.

As a result, a wearable device for detecting contaminants and warning a user inconspicuously is needed. Other advantages of the device will become apparent from the provided description below.

### BRIEF DESCRIPTION

In accordance with one aspect of the present disclosure, a wearable device for analyzing a chemical composition of a substance is provided. The device can include a source directing electromagnetic radiation at the substance and a detector detecting an intensity of the electromagnetic radiation to determine the chemical composition of the substance.

In accordance with another aspect of the present disclosure, a ring is provided. The ring can include a spectrometer detecting a chemical composition of a substance and a notification mechanism activating when the chemical composition of the substance has been tested by the spectrometer.

In accordance with yet another aspect of the present disclosure, a system for detecting a composition of a substance is provided. The system can include a processor, a spectrometer, a notification mechanism, and a memory operatively coupled to the processor, the memory storing program instructions that when executed by the processor, causes the processor to perform processes. These processes can include determining the composition of the substance through the spectrometer and activating the notification mechanism when the composition of the substance is harmful or safe.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a top perspective view of an illustrative wearable device for detecting contaminants in accordance with one aspect of the present disclosure;

FIG. 2 is a bottom perspective view of the illustrative wearable device in accordance with one aspect of the present disclosure;

FIG. 3 is an exemplary hardware schematic of the illustrative wearable device in accordance with one aspect of the present disclosure;

FIG. 4 is an exemplary system for deriving substances detected by the illustrative wearable device in accordance with one aspect of the present disclosure;

FIG. 5A provides one exemplary method for using the illustrative wearable device in accordance with one aspect of the present disclosure;

FIG. 5B provides another exemplary method for using the illustrative wearable device in accordance with one aspect of the present disclosure;

FIG. 5C depicts one exemplary method for activation of the illustrative wearable device in accordance with one aspect of the present disclosure;

FIG. 6A is an exemplary system showing multiple wearable devices for detecting contaminants in accordance with one aspect of the present disclosure;

FIG. 6B depicts an illustrative use of the exemplary system in accordance with one aspect of the present disclosure; and

FIG. 7 is another illustrative wearable device for detecting contaminants in accordance with one aspect of the present disclosure.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Generally described, the devices and methods provided herein are directed to wearables having a spectrometer for analyzing a chemical composition of a substance, The substance can be a solid, liquid, or gas. Spectrometer readings can be matched against known chemical compositions that are stored locally or remotely. After a spectrometer reading, a notification mechanism can be activated. The notification mechanism can activate when the composition of the substance has been determined or the substance is determined to be harmful and/or safe.

A number of advantages can be provided using the devices and methods described herein. The wearable can be benign and easy to use and work without user intervention. Furthermore, feedback can be provided by the wearable in a hidden or non-conspicuous manner, typically observable by the user only. The wearable can be reusable and be capable of detecting various drugs and chemical compositions which can incapacitate a person. Other advantages will become apparent from the description provided below.

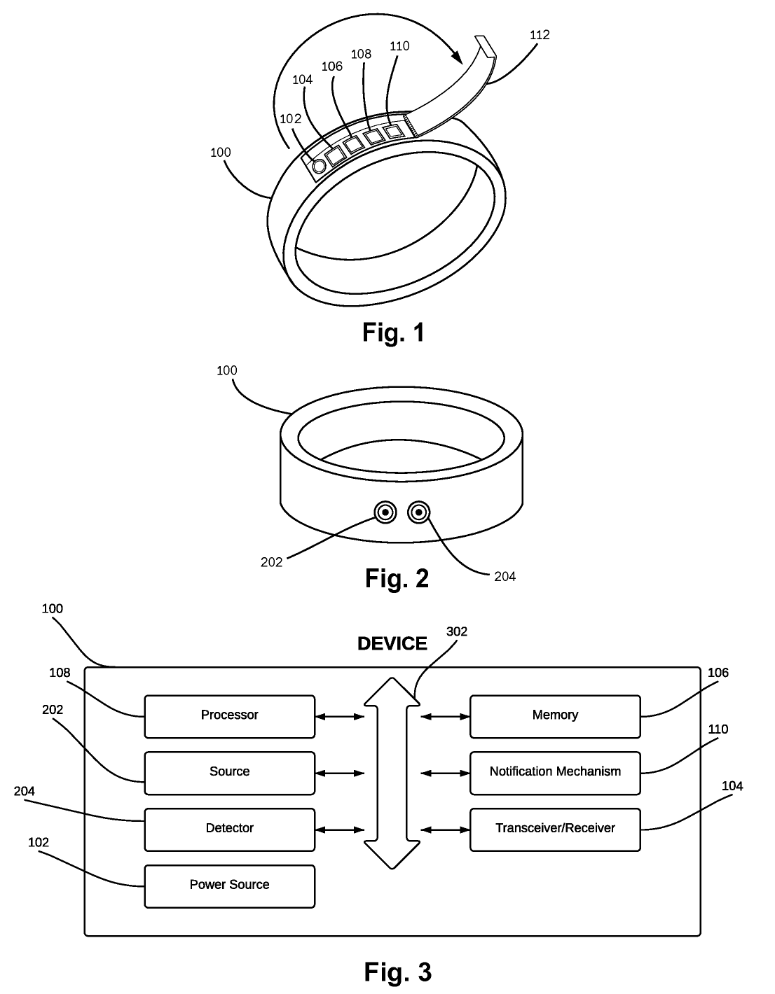

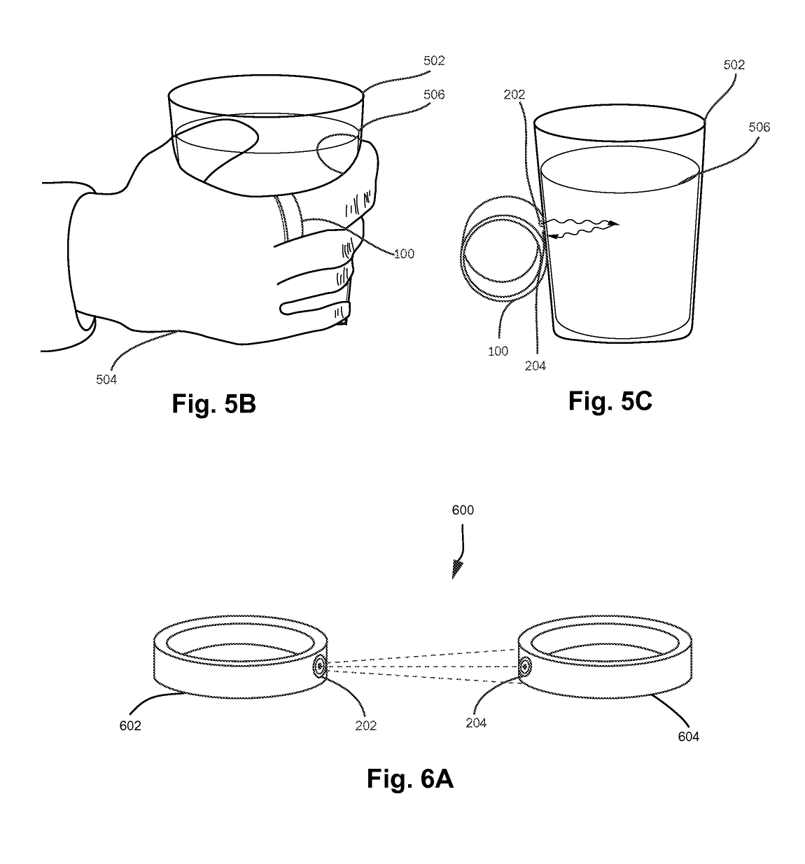

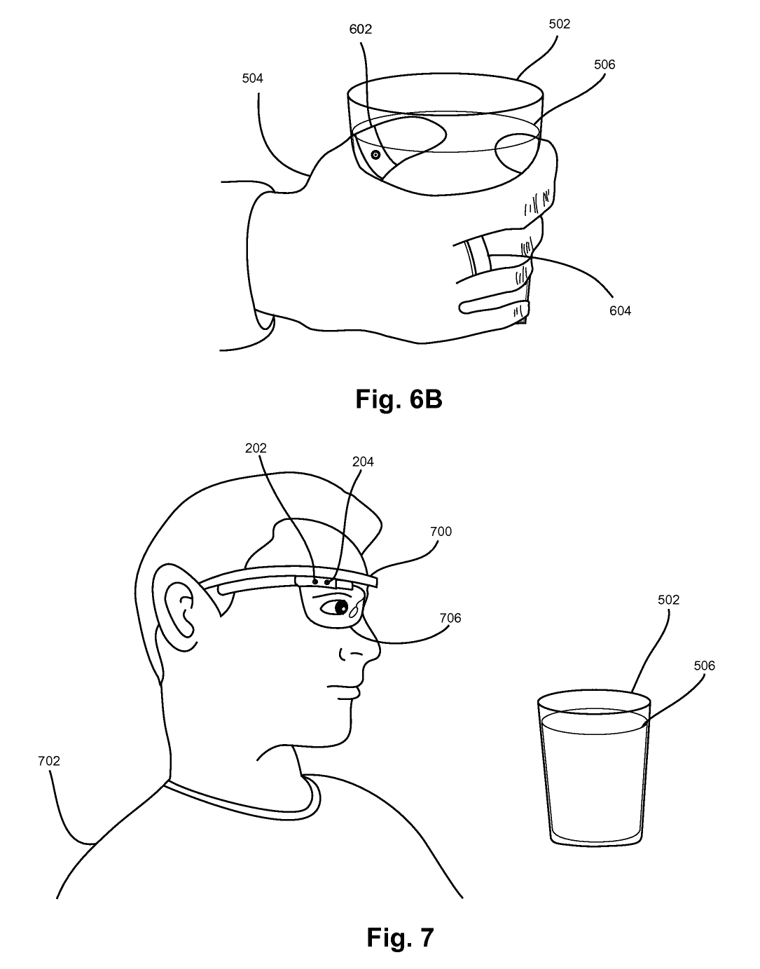

The wearable device can come in a variety of forms that will be shown through this disclosure, for example, the device can be a ring, glove, glasses, or the like. The device can include other forms of wearables not described herein and should not be limited to such. With reference now to the FIGURES, FIGS. 1 through 4 represent an embodiment of a ring for detecting the chemical composition of a substance through a spectrometer. FIGS. 5A through 5C depict a use of the ring. FIGS. 6A and 6B show a multi-ring concept while FIG. 7 illustrates the wearable within a pair of glasses.

Turning now to FIG. 1, a top perspective view of an illustrative wearable device 100 for detecting contaminants in accordance with one aspect of the present disclosure is shown. The device 100 can take the form of a ring placed over a user's finger. The device 100 can include a power source 102, transceiver/receiver 104, memory 106, processor 108, and notification mechanism 110. In addition, the device 100 can include a spectrometer, or similar apparatus, for analyzing the chemical composition of a substance, as will be detailed further below. As will become apparent, fewer or more components can be placed within the device 100 and are not necessarily limited to those shown.

The power source 102 of the device 100 can be a battery which can be implemented as one or more batteries, fuel cells, or other sources of electrical power. The power supply 102 might further include an external power source, such as an AC adapter or a powered docking cradle that supplements or recharges the batteries. The power source 102 can also be charged and/or powered wirelessly.

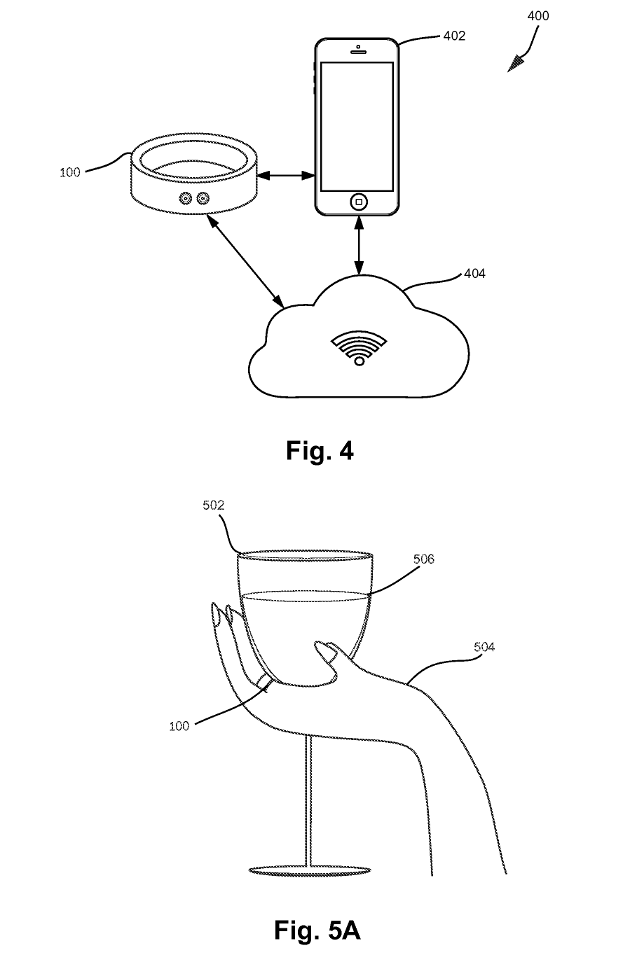

The wearable device 100 can include a transceiver/receiver 104. The transceiver/receiver 104 can be used to transmit or receive information to or from the device 100. In one embodiment, chemical compositions of substances received by a remote source can be updated on the device 100. By updating chemical compositions, the device 100 can be continuously informed of new potentially harmful or safe substances. Alternatively, the wearable 100 can send information regarding information received by the spectrometer such that the information can be processed remotely. Further details will be described below with respect to FIG. 4.

The transceiver/receiver 104 can be a Wi-Fi™ module that facilitates wireless connectivity between the wearable 100 and a remote device. In one embodiment, a wireline connection can be used instead of the transceiver/receiver 104, making the transceiver/receiver 104 an optional component within the device 100. While the transceiver/receiver 104 was described as a single component, the wearable 100 can include one or the other depending on the configuration of the device 100. In one embodiment, the wearable device 100 does not have a transceiver/receiver 104 and the analysis can be performed without updating chemical composition data.

The memory 106 of the wearable 100 can generally include both volatile memory (e.g., RAM) and non-volatile memory (e.g., ROM, Flash Memory, or the like). The non-volatile portion of the memory of can be used to store persistent information which should not be lost when the device 100 is powered down. The wearable device 100 can include a simple operating system (OS). The OS can reside in the memory 106 and be executed on the processor 108.

The processor 108 can be used to process signals and performs general computing and arithmetic functions. Signals processed by the processor 108 can include digital signals, data signals, computer instructions, processor instructions, messages, a bit, a bit stream, or other means that can be received, transmitted and/or detected. Generally, the processor 108 can be a variety of various processors including multiple single and multicore processors and co-processors and other multiple single and multicore processor and co-processor architectures. The processor 108 can include various modules to execute various functions.

The wearable 100 can include one or more audio, visual, and/or vibratory notification mechanisms 110. The notification mechanism 110 can be used to indicate a variety of conditions. For example, when a harmful substance has been detected, the notification mechanism 110 can be activated. Alternatively, the mechanism 110 can be triggered when the spectrometer has been used indicating that a reading has taken place. Various configurations can be used, for example, a first notification can indicate that a reading has taken place followed by a short notification for a safe condition or a long notification for a harmful condition.

A display can be used for the notification mechanism 110. Different colors through light emitting diodes can be used to show the various configurations, The wearable 100 could light up red when a hazardous situation is detected. Alternatively, the notification mechanism 110 can be a full graphics display having a graphical user interface to show the wearer detected information. In one embodiment, the display can show the chemical makeup of the detected substance.

In one embodiment, the notification mechanism 110 can be remote from the device 100. For example, the device 100 can send a signal through the transceiver/receiver 104 to a device such as a smartphone. The smartphone can be paired with the device 100 and receive the signal such that the notification mechanism on the smartphone can be used. This can make the notification mechanism 110 optional on the wearable device 100. In another embodiment, the signal from the device 100 can be sent to security, a friend's device, or the like alerting the proper party that a contaminant has been placed into a substance.

As shown, the wearable device 100 is a ring. In one embodiment, the ring 100 can conceal or cover the internal components such as the power source 102, transceiver/receiver 104, memory 106, processor 108, and notification mechanism 110 under a lid 112. The lid 112 can be hinged to the base of the ring 100 so that the lid 112 can flip open and shut. Other types of configurations for concealing the components of the wearable 100 can be used, for example, the top portion of the ring 100 can include an enlarged section for visual aesthetics.

The components, such as the power source 102, transceiver/receiver 104, memory 106, processor 108, and notification mechanism 110, can be easily replaceable. For example, the notification mechanism 110 can be replaced to provide different notifications such as sound instead of vibration. The power source 102 can also be replaced from a battery to a wireless source.

FIG. 2 is a bottom perspective view of the illustrative wearable device 100 in accordance with one aspect of the present disclosure. The device 100 shows typical components of a spectrometer. This configuration should not be construed as limiting however as spectrometers can come in a variety of forms and include different components. As a basic goal, the spectrometer can use the interaction of electromagnetic energy with a sample to perform an analysis. A spectrum can be created from the spectrometer plotting the intensity of energy detected versus the wavelength (or mass or momentum of frequency, etc.) of the energy. The data obtained from the spectrum of the spectrometer can be used to determine the chemical composition or makeup of a substance.

Spectrometers can come in a variety of forms and the wearable device 100 is not limited to any particular configuration or type of analysis used. For example, the spectrometer can be an absorption spectrometer that detects energy absorbed by a substance. Absorbed energy causes light to be released from the substance, which may be measured by a technique such as fluorescence spectroscopy. Attenuated total reflectance spectroscopy and the related technique called frustrated multiple internal reflection spectroscopy can be used to analyze liquids.

The spectrometer can also use electron paramagnetic spectroscopy. In this way, the device 100 can use a microwave technique based on splitting electronic energy fields in a magnetic field. Electron spectroscopy can also be used as well as a Fourier Transform spectrometer. Fourier Transform spectrometers are a family of spectroscopic techniques in which the sample is irradiated by relevant wavelengths simultaneously for a short period of time. The absorption spectrum is obtained by applying a mathematical analysis to the resulting energy pattern. Gamma-ray spectroscopy can be used which can include an activation analysis.

Infrared spectroscopy also may be used to quantify the number of absorbing molecules. Other types of spectrometers can be used such as laser spectroscopy, mass spectrometry, multiplex or frequency-modulated spectroscopy, raman spectroscopy, and x-ray spectroscopy to identify chemical compositions of substances. For purposes of the present disclosure, spectrometer, spectrophotometer, spectrograph or spectroscope can be used interchangeably. Other types of devices can be used with wearable device 100 and is not limited to containing a spectrometer for analyzing a chemical composition of a substance.

As detailed above, a number of different spectrometers can be used and integrated into the wearable device 100. The spectrometer in combination with the wearable device 100 can indicate the presence of a harmful substance, such as a date rape drug. Advantageously, the detection of the harmful substance can be performed without coming in contact with the substance. Non-visible sections of light can be used for spectroscopy to make the operation of the device discrete.

Continuing with FIG. 2, the wearable device 100 can include a spectrometer having an electromagnetic source 202 and a detector 204. While depicted as circular, the source 202 can be made in a variety of shapes and come in a number of different forms. Furthermore, and while not shown, more than one source 202 and detector 204 can be provided on the wearable device 100. Furthermore, the shown side-by-side configuration is one embodiment, but other configurations are possible for the wearable device 100.

The source on the ring 100 can transmit or radiate different types of electromagnetic radiation. Continuum sources 202 can be lamps or heated solid materials that emit a wide range of wavelengths that can be narrowed using a wavelength selection element to isolate the wavelength of interest. Line sources 202 can also be used. This can include lasers and specialized lamps that are designed to emit discrete wavelengths specific to the lamp's material. Other types of sources 202 can be used and the wearable device 100 is not limited to any particular configuration.

The detector 204 can be a transducer that transforms analog output of the spectrometer into an electrical signal that can be viewed and analyzed. Typically, there can be two types of detectors 204: photon detectors and thermal detectors. Detectors 204 can vary in size, shape, and orientation and should not be limited to the embodiment shown in FIG. 2.

Briefly described, a photon detector 204 on the wearable device 100 can work by detecting a current, number of electrons, or charge. This detection can then be related to the energy/quantity of photons that caused the change in the material for determining the compounds of a substance. Thermal detectors 204 can detect a temperature change in a material due to photon absorption. The temperature difference can be related to a potential difference, which is the output signal to detect compounds with a substance.

Through the electromagnetic source 202 and detector 204 described above, the presence and/or the absence of a harmful substance can be determined. In one example, and is common with date rape drugs, Rohypnol can be detected by screening for flunitrazepam metabolite. Analysis of flunitrazepam and its major metabolites can be detected by the spectrometer by the wearable device 100. While described as a spectrometer, the wearable device 100 is not confined to the terminology of having a spectrometer. The device 100 can include devices that have similar functions and/or features.

The spectrometer of the wearable device 100 can also detect gamma-hydroxybutyrate (GHB) within a substance. Typically GHB has no odor and is almost undetectable in a mixed drink. Benzodiazepines can also be detected within drinks using the spectrometer. Each substance provides a unique spectrum for detection by the detector 204 when electromagnetic radiation is provided by the source 202. As has become apparent from this disclosure, the ring 100 can detect a number of substances which are presently known or will be developed in the future.

In one embodiment, different alcohol percentages within a drink can be detected by the spectrometer of the wearable device 100. The wearable 100 can identify molecules based on the absorbed light. The spectrometer on the wearable 100 can also be used to detect pollutants within a liquid such as a Bisphenol A (BPA), which is common within plastics. Other types of substances that can be detected include, but are not limited to, radiation, microbes, pathogens, and salinity and/or hardness of a liquid.

FIG. 3 is an exemplary hardware schematic of the illustrative wearable device 100 in accordance with one aspect of the present disclosure. As described earlier, the components of the device 100, can include a power source 102, transceiver/receiver 104, memory 106, processor 108, notification mechanism 110, and spectrometer having a source 202 and detector 204. With the exception of the power source 102, each of the components can be coupled together through a bus 302. A bus 302 can refer to an interconnected architecture that is operably connected to other components inside a device 100. The bus 302 can transfer data between the components. The bus 302 can be a memory bus, a memory controller, a peripheral bus, an external bus, a crossbar switch, and/or a local bus, among others. Alternatively, the wearable device 100 can contain other connections coupling the components together.

In one embodiment, to preserve the power of the power source 102, the spectrometer can be activated when the source 202 and detector 204 are pressed inwards. A switch associated with both the source 202 and detector 204 can encircle the source 202 and detector 204. In one configuration, the spectrometer can be activated continuously. The device 100 can also be activated when it is worn by a user. In another embodiment, a switch on the ring 100 can be provided to turn on/off the device 100 and can be concealed by the lid 112.

A number of other configurations for turning on/off the wearable device 100 can be used. The switch can take the form of a tapping mechanisms which when tapped can turn the device 100 on/off. In one embodiment, accelerometers, or the like, that measure the acceleration/deceleration of the device 100 can be used to turn on/off the ring 100.

Turning to FIG. 4, an exemplary system 400 for deriving substances detected by the illustrative wearable device 100 in accordance with one aspect of the present disclosure is provided. Many different types of configurations can be realized and will be discussed below. Generally, the information from the spectrometer on the wearable device 100 can be processed on the device 100 or remotely. If processed on the device 100, chemical compositions of substances can be received from a smartphone 402 or network 404. Alternatively, the smartphone 402, network 404, or device on the network 404 can process data received from the wearable 100.

Described earlier, and more fully explained now, the spectrometer of the wearable device 100 can determine a chemical composition of a substance. Because substances typically change, in their chemical compositions and/or makeup, the shown system 400 can provide updates for these chemical compositions. Furthermore, this information can include tables that determine whether a substance is harmful or safe. Alternatively, the chemical compositions are updated and processed remotely.

In one embodiment, the chemical compositions can be provided within the memory 106 on the ring 100, thus not using the system 400. The chemical compositions can be updated on the ring itself via wirelessly or wireline connection including a USB port, connection to a computer, or the like. This type of downloading can be performed in a number of different ways and is not limited to those described above.

The system 400, alternatively, can provide chemical compositions of different substances and in addition, whether a substance is harmful or safe, through a number of different connections which will be shown below. The memory 106 of the wearable device 100 can either be updated or checked locally or the data from the spectrometer can be provided to a remote service through the system 400 and checked on the remote service. In some embodiments, this can remove the memory 106 on the device 100 entirely or at least partially saving room and weight costs. The data can be processed offboard or chemical composition data can be provided to the ring 100 itself.

As shown in FIG. 4, and in one embodiment, the wearable device 100 can communicate with a smartphone 402 through the transceiver/receiver 104 to retrieve or process chemical compositions. Communications can be established between the device 100 and the smartphone 402. Communications can refer to communications between two or more devices (e.g., wearable, computer, personal digital assistant, cellular telephone, network device) and can be, for example, a network transfer, a file transfer, an applet transfer, an email, a hypertext transfer protocol (HTTP) transfer, and so on. A communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

The smartphone 402 of the system 402 can be updated with the chemical compositions through a network 404. Alternatively, the compositions can be stored up in a cloud network 404. In one embodiment, and not shown in FIG. 4, a server or database can store

the chemical compositions of substances. A server is a computer or program that responds to commands from a client through the Internet or other network. A server program on a computer in a distributed network can handle business logic between users and backend business applications or data bases. Servers can provide transaction management, failure and load balancing. The server may connect with databases that are either local or remote from the server. The server can be updated from a variety of sources. When new information is received, the information can be pushed to the wearable device 100. Alternatively, the chemical compounds can be pulled periodically through when initiated by the ring 100.

A connection between the wearable device 100, to the phone 402, and finally to the network 404 was shown above. In one embodiment, the wearable device 100 can connect directly with the network 404 skipping the smartphone 402 altogether. The transceiver/receiver 104 can be used for direct communication. Typically, a pairing process could be required adding more functionality to the device 100.

FIG. 5A provides one exemplary method for using the illustrative wearable device 100 in accordance with one aspect of the present disclosure. A typical user can hold the glass 502 in this fashion. The user can place their hand 504 on the glass 502 having a substance 506 to be tested. While shown as a liquid, the substance 506 can come in a variety of other forms such as a solid or gas. Furthermore, while the drinking glass 502 is clear, other types of opaque materials can be used. Jars or bottles containing substances 506 can also be examined, and readings are not limited to smooth surfaces.

In a representative scenario, a user can place their hand 504 on the glass 502 and a reading can be taken. Several readings can be taken if the wearable device 100 has not properly evaluated the substance 506. Additional reading can be used if for example the harmful substance has not fully dispersed through the entire substance 506. The notification mechanism 110 can indicate a failed reading.

FIG. 5B provides another exemplary method for using the illustrative wearable device 100 in accordance with one aspect of the present disclosure. This posture can be more common for other types of drinks, for example, beer. The user's hand 504 can wrap around the glass 506 having the substance 506 and a reading can be taken to analyze the substance 506.

FIG. 5C depicts one exemplary method for activation of the illustrative wearable device 100 in accordance with one aspect of the present disclosure. As shown, the source 202 can send out electromagnetic radiation in the form of non-visible or visible light. The wearable device 100 can then receive data through the detector 204.

In turn, the spectrometer of the wearable device 100 can then take onboard measurements and process them locally on the device 100 itself or wirelessly send them to a smartphone 402 for processing. In one embodiment, the data can also be processed through a device on the network 404 or on the cloud.

As shown, an absorption spectrometer is implanted into the ring 100. However, other chemical analysis techniques can be used which were described earlier. The electromagnetic source 202 and detector 204 can be positioned such that the substance 506 can be excited by the source 202 and energy released therefrom can be picked up by the detector 204. In one embodiment, the angle of the source 202 and detector 204 can each be moved automatically such that a proper analysis can be taken. Other ways of holding a glass 506 with a substance 506 are encompassed within the present disclosure and are not limited to those shown.

Previously, a single wearable device 100, in the form of a ring 100, was shown that encompassed the components for testing a substance 506. FIG. 6A is an exemplary system 600 showing multiple wearable devices 602 and 604 for detecting contaminants in accordance with one aspect of the present disclosure. In this embodiment, the spectrometer can be split into its source 202 and detector 204. One ring 602 can have the source 202 while another ring 604 has the detector 204. The rings 602 and 604 can communicate with one another through their transceivers and/or receivers and can include similar components to the wearable device 100 described earlier.

FIG. 6B depicts an illustrative use of the exemplary system 600 in accordance with one aspect of the present disclosure. The source 202 and the detector 204, although separate from each other, can be used to detect the chemical composition of the substance 506 through the glass 502. There are a number of different ways to hold the glass 502 and only one example is shown by the user's hand 504. Mechanisms within the source 202 and the detector 204 can be used such that they can automatically be positioned so that a reading of the substance 506 can be taken.

Referring now to FIG. 7, another illustrative wearable device for detecting contaminants in accordance with one aspect of the present disclosure is provided. In this case, the wearable device is a pair of glasses 700. Substance 506 in the glass 502 can be determined by the user 702 wearing the set of glasses 700.

The glasses 700 can include similar components as the wearable device 100 described above. In addition, a lens 706 on the glasses 700 can show information regarding the substance 506. Readings can be taken by the spectrometer having the source 202 and the detector 204. In an illustrative use, the user 702 can look into the glass 502 and the substance 506 can be analyzed. The results can then be displayed on the lens 706 as to whether the drink is safe or dangerous.

While not shown, the spectrometer applied to a wearable can be used in other contexts. For example, the spectrometer can be brought into a glove. A reading could be activated when the user 702 places the glove on and motion is captured indicating that their hand 504 is over a glass 502. Other types of wearables can be used to detect contaminants within the substances 506, for example, on a necklace, watch, personal device, or the like. Chemical compositions can be determined locally or remotely and are both envisioned in the present disclosure.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A wearable device for analyzing a chemical composition of a substance comprising:
a source directing electromagnetic radiation at the substance; and
a detector detecting an intensity of the electromagnetic radiation to determine the chemical composition of the substance.

2. The wearable device of claim 1, wherein the detector detects the intensity of the electromagnetic radiation passing or reflecting through the substance to determine the chemical composition of the substance.

3. The wearable device of claim 1, comprising a notification mechanism activating when the substance is determined harmful or safe.

4. The wearable device of claim 3, comprising memory storing chemical compositions of substances.

5. The wearable device of claim 4, wherein the memory is updated with the chemical compositions of substances from a remote source.

6. The wearable device of claim 1, wherein the remote source is at least one of a smartphone, cloud based network, and smartphone with cloud based network.

7. The wearable device of claim 1, wherein the source and detector are activated when pressed against a surface or manually activated.

8. The wearable device of claim 1, comprising at least one processor, memory, and power source on an upper portion of the wearable device with the source and the detector on a bottom end of the wearable device.

9. The wearable device of claim 1, comprising a wireless source powering or charging the source and detector.

10. A ring comprising:
a spectrometer detecting a chemical composition of a substance; and
a notification mechanism activating when the chemical composition of the substance has been tested by the spectrometer.

11. The ring of claim 10, comprising a power source providing energy to the spectrometer and notification mechanism.

12. The ring of claim 10, wherein the spectrometer comprises a source and a detector.

13. The ring of claim 10, wherein the spectrometer is an absorption spectrometer.

14. The ring of claim 10, wherein the notification mechanism is at least one of a vibrator, speaker, display and combination thereof.

15. The ring of claim 10, comprising a transmitter in communication with a smartphone.

16. The ring of claim 10, wherein the spectrometer and notification mechanism are within the ring or attachments to the ring.

17. A system for detecting a composition of a substance comprising:
a processor;
a spectrometer;
a notification mechanism; and
a memory operatively coupled to the processor, the memory storing program instructions that when executed by the processor, causes the processor to:
determine the composition of the substance through the spectrometer;
activate the notification mechanism when the composition of the substance is harmful or safe.

18. The system of claim 17, wherein the spectrometer comprises a source and detector on different rings.

19. The system of claim 17, wherein the substance is a liquid.

20. The system of claim 17, wherein the system is a pair of glasses or gloves.
